(19) United States
(12) Patent Application Publication
(10) Pub. No.: US 2006/0067353 A1
(43) Pub. Date: Mar. 30, 2006

(54) Providing information in a cellular communication network

(75) Inventors: Johanna Pekonen, Espoo (FI); Guillaume Sebire, Espoo (FI); Igor Curcio, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/998,137

(22) Filed: Nov. 29, 2004

(30) Foreign Application Priority Data
Sep. 29, 2004 (FI) 20041267

(51) Int. Cl. H04J 3/26

(52) U.S. Cl. 370/432

(57) ABSTRACT

A method provides information in a cellular communication network. The method comprises broadcasting a point-to-multipoint service in at least one cell. The method further comprises providing an indication for determining a time point on which requesting a point-to-multipoint service session of the point-to-multipoint service is to be stopped in the at least one cell. The service may be a multimedia broadcast and/or multicast service. The indication may be an indication of a lifetime of the service session.

### FIELD OF THE INVENTION

The invention relates to communication systems, and more particularly to providing information in a cellular communication network. In particular, the invention relates to providing information relating to point-to-multipoint services broadcast in at least one cell, such as a multimedia broadcasting and/or multicasting service.

### BACKGROUND OF THE INVENTION

A communication system can be seen as a facility that enables communication sessions between two or more entities such as a communication device and/or other nodes associated with the communication system. Subscribers, such as the users or end-users, to a communication system may be offered and provided numerous services, such as two-way or multi-way calls, data communication or multimedia services or simply an access to a network, such as the Internet. The services may be offered by an operator of a network of the communication system or by an external service provider.

A communication system typically operates in accordance with a given standard or specification setting out what the various entities associated with the communication system are permitted to do and how that should be achieved. A standard or specification may define a specific set of rules, such as communication protocols and/or parameters, on which connections between the entities can be based.

Wireless communication systems include various cellular or otherwise mobile communication systems using radio frequencies for sending voice or data between stations, for example between a communication device and a transceiver network element. Examples of wireless communication systems may comprise public land mobile network (PLMN), such as global system for mobile communications (GSM), general packet radio service (GPRS) and universal mobile telecommunications system (UMTS) using, for example, wideband code division multiple access (WCDMA) technology. Further examples of wireless communication systems may comprise wireless local area network (WLAN), wireless packet switched data networks, such as a wireless Internet Protocol (IP) network and so on. Wireless communication systems may be connected to other wireless communication systems or wired communication systems, such as a public switched telephone network (PSTN). Various communication systems may simultaneously be concerned in a connection.

An end-user may access a communication network by means of any appropriate communication device, also called terminal. Examples may comprise user equipment (UE), a mobile station (MS), a cellular phone, a personal digital assistant (PDA) and a personal computer (PC). Further examples may comprise any other equipment operable according to a suitable network or transport protocol, such as a Session Initiation Protocol (SIP), a Real-Time Transmission Protocol (RTP), a File Delivery over Unidirectional Transport (FLUTE), a wireless applications protocol (WAP) or a hypertext transfer protocol (HTTP).

A user of a wireless communication device may access a communication network via a radio access network (RAN) comprising transceiver network elements, such as Node B or base transceiver station (BTS), and typically controlled by an appropriate controller network element, such as radio network controller (RNC) or base station controller (BSC). Examples of radio access networks may comprise the UMTS terrestrial radio access network (UTRAN) and the GSM/EDGE radio access network (GERAN).

A cellular system may include a broadcasting entity, such as a multimedia broadcast/multicast service (MBMS) center or server, which is able to broadcast or multicast information to unspecified number of receivers, such as mobile stations, over a geographical area. The MBMS may thus provide a point-to-multipoint (p-t-m) service. A reference architecture to support MBMS is defined by the Third Generation Partnership Project (3GPP) in 3GPP TS 23.246 V.6.3.0 (2004-06) “3rd Generation Partnership Project; Technical Specification Group services and System Aspects; Multimedia Broadcast/Multicast Service (MBMS); Architecture and functional description (Release 6)”, paragraph 4.2. Existing packet switched domain functional entities of a 3GPP system, such as a gateway GPRS support node (GGSN), a serving GPRS support node (SGSN), UTRAN, GERAN, UE, may be enhanced to provide an MBMS bearer service. Other functional entities may be provided, such as an MBMS server or a Broadcast Multicast Service Center (BM-SC).

An MBMS server or other appropriate entity may provide information of different MBMS services to receivers. One MBMS service may consist of one or more sessions. The receivers may subscribe and join to a session of an MBMS service in order to receive the data. Furthermore, the receivers of an MBMS session sent by a given cell on a p-t-m channel may be provided with neighboring cell information of a neighboring cell sending the same session on a p-t-m channel. However, there may be occasions, when the neighboring cell information is not available prior to changing the cell.

3GPP TS 43.246 V6.0.0 (2004-08) “3rd Generation Partnership Project; Technical Specification Group GSM/EDGE Radio Access Network; Multimedia Broadcast Multicast Service (MBMS) in the GERAN; Stage 2 (Release 6)”, paragraph 6.2.2, defines an MBMS reception resumption after cell reselection. A terminal having an ongoing session may reselect a new cell, even if the terminal has not received neighboring cell information relating to the reselected cell. The terminal does not know whether an MBMS bearer is allocated in the reselected cell for the MBMS session in question. In such a situation, the terminal requests the MBMS service from the network for the ongoing session to which the terminal had started to receive data before the cell reselection. Upon receipt of such a request by the radio access network, the network may provide an MBMS traffic channel configuration for the MBMS session in question or indicate that no p-t-m bearer will be available.

There is no MBMS specific cell reselection algorithm. General rules for cell selection and reselection have been defined, for example, in 3GPP TS 45.008 V4.15.0 (2004-08) “3rd Generation Partnership Project; Technical Specification Group GSM/EDGE Radio Access Network; Radio subsystem link control (Release 4), see e.g. paragraphs 6 and 10. The cell re-selection procedures defined in sub-clauses 10.1.1 to 10.1.3 of 3GPP TS 45.008 V4.15.0 (2004-08) apply in A/Gb mode to the MSs attached to GPRS if a PBCCH (Packet Broadcast Control Channel) exists in the serving cell. In lu mode these procedures apply always. Data of an MBMS session can be transmitted inside an MBMS service area. An MBMS service area may contain cells from one up to the whole PLMN.

A typical cell reselection scenario during an MBMS session may contain three almost equally strong cells. At the border of the MBMS service area, a terminal listening to the MBMS session may reselect a cell outside the MBMS service area. The data reception may thus be stopped even if the terminal has not moved physically. In 3GPP TS 43.246, it is not defined, how the terminal shall act in such a situation.

In an approach, the terminal may stop listening to the MBMS session after the terminal has received once from the network an indication: “no p-t-m bearer available”. With this approach, there can be a risk that the terminal reselects a cell close to the service area border, which cell does not belong to the MBMS service area. Hence, the reception of the data may be stopped, although there might be a third cell able to provide the data of the ongoing MBMS session. In an alternative approach, the terminal may request the ongoing MBMS service always when entering a new cell supporting the MBMS. The terminal does not know whether this session is ongoing in the new cell. The terminal may thus miss an indication that the MBMS session is stopped. It may result in the terminal continuing to request the MBMS service and the session for a long time or even indefinitely after the session has stopped.

It shall be appreciated that these issues are not limited to any particular communication environment, but may occur in any appropriate communication system.

### SUMMARY OF THE INVENTION

Embodiments of the invention aim to address one or several of the above problems or issues.

In accordance with an aspect of the invention, there is provided a method for providing information in a cellular communication network. The method comprises broadcasting a point-to-multipoint service in at least one cell. The method further comprises providing an indication for determining a time point on which requesting a point-to-multipoint service session of the point-to-multipoint service is to be stopped in the at least one cell.

In accordance with a further aspect of the invention, there is provided a method for receiving information in a cellular communication network. The method comprises requesting for a point-to-multipoint service session broadcast in at least one cell. The method further comprises receiving an indication. The method further comprises determining, based on the indication, a time point on which requesting the point-to-multipoint service session is stopped in the at least one cell.

In accordance with a further aspect of the invention, there is provided a method for controlling requesting for a point-to-multipoint service session broadcast in at least one cell. The method comprises requesting for the point-to-multipoint service session in a cell. The method further comprises receiving an indication. The method further comprises determining, based on the indication, a time point on which requesting the point-to-multipoint service session is to be stopped in the at least one cell. The method further comprises reselecting a second cell. The method further comprises repeating the steps of requesting and reselecting. The method further comprises controlling when the time point is reached. The method further comprises stopping to request the point-to-multipoint service session in the at least one cell when the time point is reached.

In accordance with a further aspect of the invention, there is provided an indication for a point-to-multipoint service broadcast in at least one cell in a cellular communication network, the indication configured to allow determination of a time point on which requesting a point-to-multipoint service session of the point-to-multipoint service is to be stopped in the at least one cell.

In accordance with a further aspect of the invention, there is provided a broadcasting entity in a cellular communication network. The broadcasting entity is configured to broadcast a point-to-multipoint service in at least one cell. The broadcasting entity is further configured provide an indication for determining a time point on which requesting a point-to-multipoint service session of the point-to-multipoint service is to be stopped in the at least one cell.

In accordance with a further aspect of the invention, there is provided a broadcasting entity in a cellular communication network, comprising a broadcaster for broadcasting a point-to-multipoint service in at least one cell and an indication provider for providing an indication for determining a time point on which requesting a point-to-multipoint service session of the point-to-multipoint service is to be stopped in the at least one cell.

In accordance with a further aspect of the invention, there is provided a communication network. The communication network is configured to broadcast a point-to-multipoint service in at least one cell. The communication network is further configured to provide an indication for determining a time point on which requesting a point-to-multipoint service session of the point-to-multipoint service is to be stopped in the at least one cell.

In accordance with a further aspect of the invention, there is provided a communication device. The communication device is configured to request for a point-to-multipoint service session broadcast in at least one cell. The communication device is further configured to receive an indication. The communication device is further configured to determine, based on the indication, a time point on which requesting the point-to-multipoint service session is stopped in the at least one cell.

In accordance with a further aspect of the invention, there is provided a communication device. The communication device is configured to request for the point-to-multipoint service session in a cell. The communication device is further configured to receive an indication. The communication device is further configured to determine, based on the indication, a time point on which requesting the point-to-multipoint service session is to be stopped in the at least one cell. The communication device is further configured to reselect a second cell. The communication device is further configured to repeat the steps of requesting and reselecting. The communication device is further configured to control when the time point is reached. The communication device is further configured to stop to request the point-to-multipoint service session in the at least one cell when the time point is reached.

In an embodiment, the service comprises a multimedia broadcast and/or multicast service.

In an embodiment, the indication is an indication of a lifetime of the service session.

The indication may comprise at least one of an indication of relative time duration of the service session, an absolute time indication of a stopping time of the service session, an amount of data to be transmitted during the service session, information of provision of a point-to-multipoint type of file repair and a safety period to be added in actual stopping time of the service session.

### BRIEF DESCRIPTION OF THE DRAWINGS

The invention will now be described in further detail, by way of example only, with reference to the following examples and accompanying drawings, in which:

FIG. 1 shows an example of an arrangement in which the embodiments of the invention may be implemented;

FIG. 2 shows a flow chart illustrating an embodiment of the invention;

FIG. 3 shows a flow chart illustrating a further embodiment of the invention;

FIG. 4 shows a flow chart illustrating a further embodiment of the invention;

FIG. 5 shows a flow chart illustrating a further embodiment of the invention;

FIG. 6 shows a flow chart illustrating a further embodiment of the invention;

FIG. 7 shows a flow chart illustrating a further embodiment of the invention; and

FIG. 8 shows a flow chart illustrating a further embodiment of the invention.

### DETAILED DESCRIPTION OF PREFERRED EMBODIMENTS

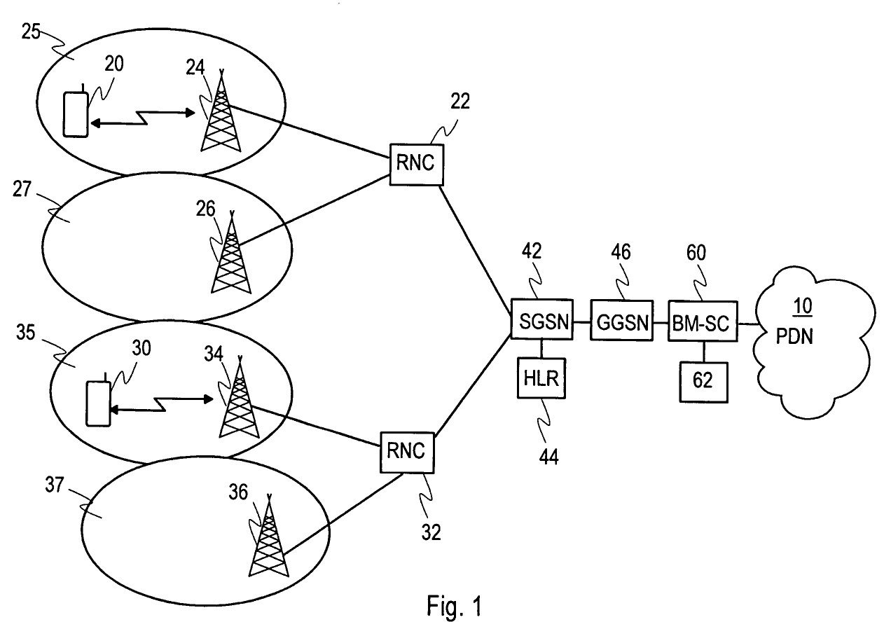

Reference is made to FIG. 1 showing an example of a network architecture in which the embodiments of the invention may be implemented. In FIG. 1, a public data network (PDN) 10 is provided for offering data services. An example of the PDN 10 may comprise, but is not limited to, the Internet Protocol (IP) Multimedia Subsystem (IMS).

Data services can be provided with mobile communication devices via a mobile communication system. A mobile communication system is typically arranged to serve a plurality of mobile communication devices usually via a wireless interface between the communication device and at least one transceiver network element of the communication system, such as a base transceiver station (BTS) or a Node B. The mobile communication system may logically be divided between a radio access network (RAN) and a core network (CN).

In the arrangement of FIG. 1, a communication device 20 is arranged to access the core network via a radio access network comprising a transceiver network element 24 and a controller network element 22. The communication device 20 is arranged to transmit signals to and receive signals from the transceiver network element 24 via a wireless interface between the communication device and the transceiver network element. Correspondingly, the transceiver network element is able to transmit signals to and receive signals from the communication device via the wireless interface. Furthermore, the controller network element 22 is shown to control a second transceiver network element 26.

A transceiver network element typically serves a geographical area or a plurality of geographical areas. Such a geographical area may also be referred to as a cell. In FIG. 1, the transceiver network element 24 is shown to serve a cell 25 and the transceiver network element 26 is shown to serve a cell 27.

Correspondingly, a communication device 30 is arranged to access the core network via a radio access network comprising a transceiver network element 34 and a controller network element 32. The controller network element 32 controls also a second transceiver network element 36. The transceiver network element 34 serves a cell 35 and the transceiver network element 36 serves a cell 37.

It shall be appreciated that, although for clarity reasons FIG. 1 shows only four exemplifying transceiver network elements and two exemplifying controller network elements, a typical communication network system usually includes a number of radio access networks. A controller may be assigned for each transceiver network element or a controller can control a plurality of transceiver network elements, for example in the radio access network level. It shall be appreciated that the name, location and number of the network controllers depend on the system. Furthermore, although only two communication devices are shown in FIG. 1 for clarity, a number of user equipment and/or other communication devices may be in simultaneous communication with transceiver network elements of a communication system.

The core network (CN) entities typically include various switching and other control entities and gateways for enabling the communication via a number of radio access networks and also for interfacing a single communication system with one or more communication systems, such as with other cellular systems and/or fixed line communication systems. In the 3GPP systems, the radio access network controller is typically connected to an appropriate core network entity or entities such as, but not limited to, a serving general packet radio service support node (SGSN) 42. The radio access network controller is in communication with the SGSN via an appropriate interface, for example on an lu or Gb interface. The SGSN may communicate with a subscriber information database, such as a home location register (HLR) 44. The SGSN 42 also typically communicates with a gateway GPRS support node (GGSN) 46. This interface may be, for example, a Gn/Gp interface.

In a 3GPP network, a packet data session is established to carry traffic flows over the network. Such a packet data session is often referred to as a packet data protocol (PDP) context. A PDP context may include a radio bearer provided between the communication device and the radio network controller, a radio access bearer provided between the communication device, the radio network controller and the SGSN, and switched packet data channels provided between the SGSN and the GGSN. Each PDP context usually provides a communication pathway between a particular communication device and the GGSN and, once established, can typically carry multiple flows. Each flow normally represents, for example, a particular service and/or a media component of a particular service. The PDP context therefore often represents a logical communication pathway for one or more flow across the network. To implement the PDP context between a communication device and the SGSN, radio access bearers (RAB), i.e. logical and physical channels, need to be established which commonly allow for data transfer for the communication device.

Furthermore, FIG. 1 shows a broadcast multicast service center (BM-SC) 60, which provides functions for MBMS service provisioning and delivery. The BM-SC 60 may serve as an entry point for MBMS transmissions of a content provider 62 providing broadcast or multicast data to communication devices situated in a geographical area served by the BM-SC 60. The BM-SC 60 may broadcast information in the area or provide information of different multicasting groups to communication devices in the area. The BM-SC 60 may be used to authorize and initiate MBMS bearer services within a cellular network and can be used to schedule and deliver MBMS transmissions.

In 3GPP TS 26.346 v 1.0.0, “3rd Generation Partnership Project; Technical Specification Group Services and System Aspects; Multimedia Broadcast/Multicast Service; Protocols and Codecs (Release 6)”, paragraph 5.2, an MBMS service announcement is defined. The MBMS service announcement contains information about a forthcoming MBMS service or about a certain session of an MBMS service. Starting and stopping time of a session are typically part of that information.

Starting time of a session, or session start, is a point at which an entity responsible of providing MBMS services in a cellular network, such as the BM-SC, is ready to send data. The session start also notifies communication devices that data transmission shall start shortly. The session start is not dependent of activation of the respective service by a user, but a user may activate the service before or after the session start. With stopping time of the session, or session stop, typically the BM-SC may determine that there will be no more data to send for a period of time, which is long enough to justify removal of network resources associated with the session. At the session stop, the network resources may be released. Furthermore, the session stop may be used to trigger for so called file repair mechanism (either via a point-to-point or point-to-multipoint network connection) that is used to fetch data blocks, which were erroneously received or totally missed during the MBMS session. Other triggers for the file repair may also be possible.

Such a repair-mechanism for MBMS services to provide the terminal the missed packets of a certain session after the session has stopped is defined in 3GPP TS 26.346, paragraph 6.3.2.1. The current mechanism may use an ordinary point-to-point connection, e.g. GPRS or WCDMA, to fetch the needed and/or missing data packets. The terminal may set up a point-to-point connection and connect to the BM-SC or to a predefined repair server. The terminal may indicate in an uplink signaling, which packets the terminal would like to have retransmitted. The network, through the BM-SC or another appropriate repair server, may provide the requested data packets using a downlink of said point-to-point connection.

It has been proposed that the repair operation might be performed via a point-to-multipoint connection. This may enable utilizing efficiently the multicast/broadcast bearer for repair functionality in cases of, for example, multiple receivers requesting the retransmission of the same set of packets. The MBMS bearer should then be kept active for a certain time, even after the end of the first data transmission, or in other words, after the end of the MBMS session, in order to enable the transmission of the repair session. If the repair is done in point-to-multipoint fashion, receivers may be informed at a service announcement prior the start of the session. Receivers may also be informed at the end of the session, for example by means of a “repair token” signaling, that a repair session will follow via point-to-multipoint.

It has now been found that the stopping time information or another indication of a lifetime of the service session may be used to define a time point after which the terminal shall not anymore request for the service, such as the MBMS service which it has been listening to, when entering a cell supporting the service, such as the MBMS.

As explained above, a repair mechanism may be carried out using a point-to-multipoint MBMS bearer. If a terminal is aware of the repair mechanism, the terminal may continue to request for the MBMS service after a cell reselection to a cell supporting the MBMS until the terminal has received through the repair mechanism all the missing data packets requested for. In an embodiment, the terminal may continue to request for the MBMS service after a cell reselection until the terminal will notice that all the data packets requested for have already been transmitted by the network during the repair period, even if all have not been received. The terminal may be able to notice which data packets the repair server has retransmitted, because the data packets are retransmitted by the repair mechanism in a single message. The message contains a length indication based on which the terminal can assume the duration time of the point-to-multipoint repair transmission. In this case, if not all the requested packets are received after the repair session, the receiving terminal can issue a second repair request to the repair server for the residual missing packets. The terminal may then wait for a further retransmission via the point-to-multipoint bearer. In an alternative, the receiving terminal can request those packets exclusively via a point-to-point connection.

An indication for repair in point-to-multipoint may have been sent right after the session has stopped, but the terminal may have missed the indication. Then, the terminal may thus not be aware of the point-to-multipoint repair. In such a case, the terminal may be able to use the point-to-point repair mechanism, if needed.

To be able to use the point-to-multipoint repair mechanism, the terminal needs a capability to maintain a simultaneous point-to-point connection and point-to-multipoint MBMS connection. A terminal without this capability will use the point-to-point repair mechanism.

In this specification the definition “session stop time” may denote and is intended to cover two situations. Firstly, the session stop time may be a time, when the session is actually stopped. Secondly, the session stop time may be a time point, which is reached when summing the time, when the session is actually stopped, and a time period until the network has transmitted via a point-to-multipoint bearer data packets, which a terminal or a plurality of terminals have requested using the repair mechanism. The time period for the point-to-multipoint repair embodiment may be terminal specific or network specific.

In an embodiment, the terminal may have an ongoing MBMS session. When entering a new MBMS cell, the terminal may request for the ongoing session, even if the terminal does not have any pre-information about the MBMS services provided in the new cell. The terminal may request for the ongoing MBMS session every time when entering a cell supporting the MBMS. In an alternative, the terminal may request for the ongoing MBMS session then only when entering a given cell supporting MBMS for the first time during the ongoing MBMS session.

The terminal may request for the service session only once after the cell reselection or more than once. This could depend on what the network responses to a request. This may provide advantages, in a case of congestion in the network. The network may indicate, that currently no p-t-m is allocated. Another cell, which does not belong to the service area of that particular MBMS service, may respond with a message “service not available in this cell” or the like. The terminal may thus proceed in at least two different ways. In an embodiment, the terminal may ask later on again for the service after a pre-defined time period. In another embodiment, the terminal shall not ask again for the service, because the terminal already received information, that this cell does not belong to the service area of the requested MBMS service.

The terminal may stop requesting the session when the terminal has received a session stop message or indication via a serving cell. In an alternative, the terminal may stop requesting the session when the terminal can assume, based on any pre-information or time indication, that the session has stopped. Such time indication may comprise, for example, session stop time defined in the service announcement. The time indication may also be given in an MBMS joining phase or during an MBMS session start or anytime before the session is stopped.

The MBMS joining, as defined in 3GPP TS 23.246, is MBMS multicast activation by a user. The user indicates to the network that the user is willing to receive multicast mode data of a specific MBMS bearer service. In other words, joining is a process by which a subscriber becomes a member of a multicast group.

The MBMS session start is defined, for example, in 3GPP TS 23.246, paragraph 8.3. An MBMS Session Start Request message typically contains information about the estimated session duration. This information may be indicated in time units or as a data amount to be transmitted or a time point. A controlling entity, such as a RNC or BSC, may receive the MBMS Session Start Request message from a SGSN, when necessary bearer resources for transmission are activated.

In an embodiment, the time indication may be given as relative time duration of the service session, e.g. duration of a given session, or an absolute time indication of a stopping time of the service session, e.g. a time of the day. Furthermore, the indication may be given as an amount of data to be transmitted during the service session. Furthermore, the indication may comprise information of provision of a point-to-multipoint type of file repair. Furthermore, a safety period may be given to be added in an actual stopping time of the service session, the actual stopping time being obtained from other information comprised in the indication. In an embodiment, a combination of different indications is given. For example, the network may directly broadcast a time point obtained by summing the actual stop time and a safety period.

As mentioned above, the estimated session duration may be indicated as the data amount to be transmitted. In an embodiment, the controlling entity may convert said information into the time units, which tell the session duration time. The controlling entity may indicate in an MBMS notification or in an MBMS assignment message to the terminals an expected duration time of the session. A terminal receiving the MBMS notification or the MBMS assignment message may store the estimated duration time until the session is stopped. This information should be updated always when received after a cell change, in a similar manner as other MBMS channel allocation related data. Thus, the latest version of this information applies.

In an embodiment, the terminal may estimate the duration time by the indicated total data amount and the used data rate.

In an embodiment, the terminal shall not request for the service after the terminal has received session stop indication. In an embodiment the terminal shall not request for the service after the session duration has exceeded the time indicated during the session setup or start or in the latest MBMS assignment message. In an embodiment, the terminal is informed that a point-to-multipoint type of file repair is provided or another indication indicating that the point-to-multipoint bearer is required after the session stop time. In this embodiment, the terminal may continue to request for the service for the period when the point-to-multipoint bearer is required.

In some cases, the indicated time point may be inexact. However, the time point may provide the duration time in a reasonable range in most cases.

In an embodiment, some extra time may be added to the duration time or stopping time. The terminal may request for the session during said extra time after the session has stopped. However, there is a point where requesting stops, thus not continuing forever. In an embodiment, the network may provide a safety period value, which the terminal may add to the initial, indicated stop time point. The sum of the initial, indicated stop time point and the safety period value may then be used as an actual stop time point for stopping to request for the service.

In an embodiment, the terminal may request for the missing packets after the MBMS session using the repair mechanism explained above. Two situations may look similar from the terminal point of view: The terminal being outside an MBMS service area for the rest of the transmission of a certain MBMS session and the terminal just accidentally stopping to request for a certain service after a cell reselection, although the session is still going on.

The terminal may use the indication of the session duration time or stopping time for controlling whether the MBMS service shall be requested after entering a new cell. However, to stop the reception of the MBMS data in the current cell, the known MBMS Session Stop message in accordance with the 3GPP TS 23.246 V.6.3.0 (2004-06), paragraph 8.5, or similar may be used.

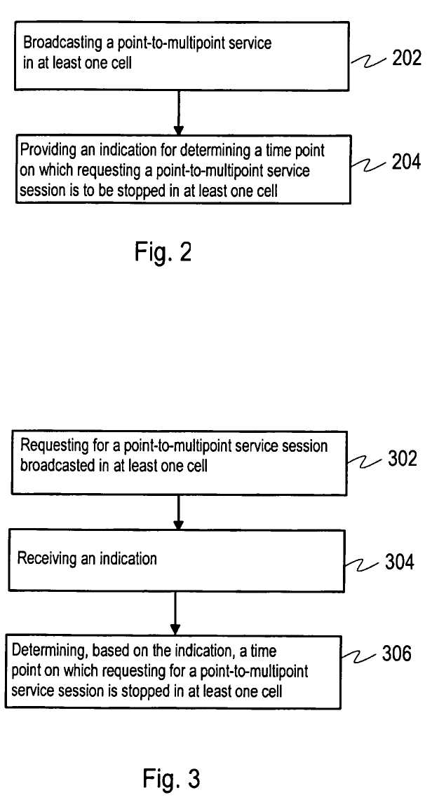

FIG. 2 shows an embodiment of the invention. In step 202, a point-to-multipoint service is broadcast in at least one cell. The point-to-multipoint service may comprise the multimedia broadcast multicast services. An entity broadcasting the service may be a broadcast/multicast service center or another appropriate entity. In step 204, a time indication is provided for determining a time point on which requesting a point-to-multipoint service session is to be stopped in the at least one cell.

FIG. 3 shows a further embodiment of the invention. In step 302, a point-to-multipoint service session broadcast in at least one cell is requested for. For example, a communication device configured to receive such a point-to-multipoint service session may be a requester. In step 304, a time indication is received. In step 306, a time point is determined based on the time indication, on which time point requesting the point-to-multipoint service session is stopped in the at least one cell. The time point may be the actual end of the session or another appropriate time point, such as the actual session stop extended by a given safety period. Other time points, some examples of which were given above, may also be used.

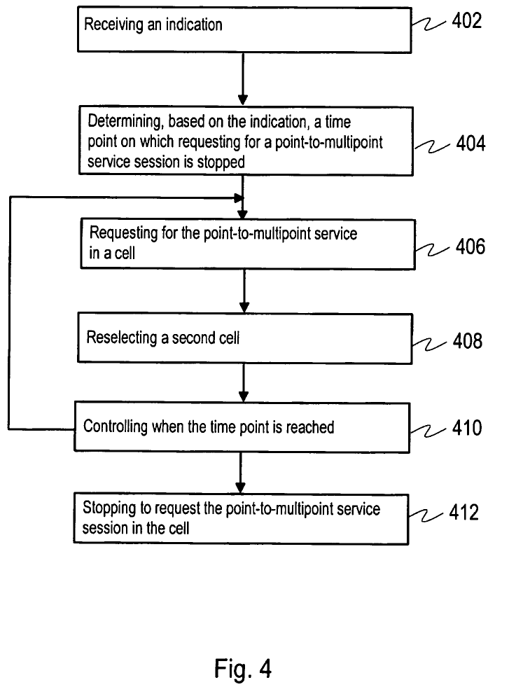

FIG. 4 shows a further embodiment of the invention. In step 402, a time indication is received. In step 404, based on the time indication, a time point is determined on which requesting for a point-to-multipoint service session is to be stopped. In step 406, the point-to-multipoint service broadcast in at least one cell in a network is requested for in a cell. In step 408, a second cell is reselected. In step 410, reaching the time point is controlled. When the time point is reached, requesting the point-to-multipoint service session in the cell is stopped in step 412. Steps 406, 408 and 410 may be repeated as long as the time point is reached.

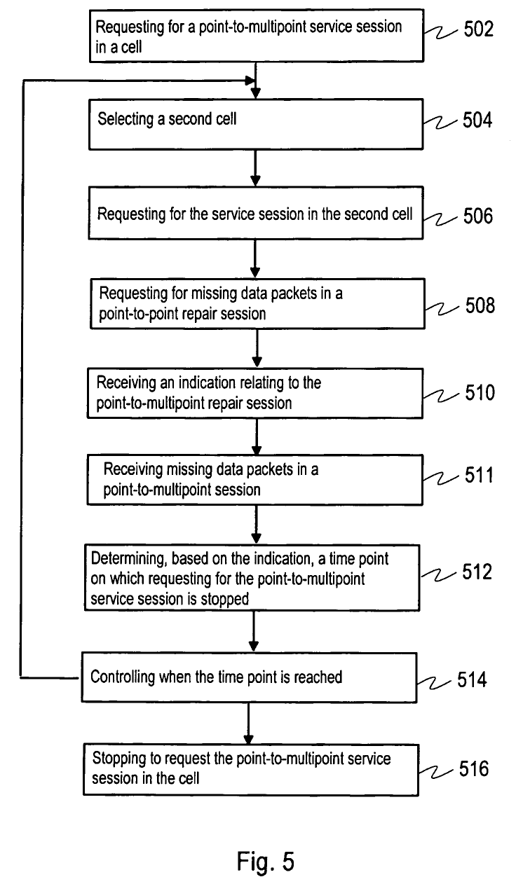

FIG. 5 shows a further embodiment of the invention. In step 502, a point-to-multipoint service session is requested for in a cell. In step 504, a second cell is selected. In step 506, the service session is requested for in the second cell. In step 508, missing data packets are requested for in a point-to-point repair session. In step 510, an indication relating to the point-to-multipoint repair session is received. In step 511, missing data packets are received in a point-to-multipoint repair session. In step 512, based on the indication, a time point is determined on which requesting for the point-to-multipoint service session is stopped. In step 514, reaching the time point is controlled. In step 516, when the time point is reached, requesting the point-to-multipoint service session in the cell is stopped. In an embodiment, steps 504, 506, 508, 510, 511, 512 and 514 may be repeated.

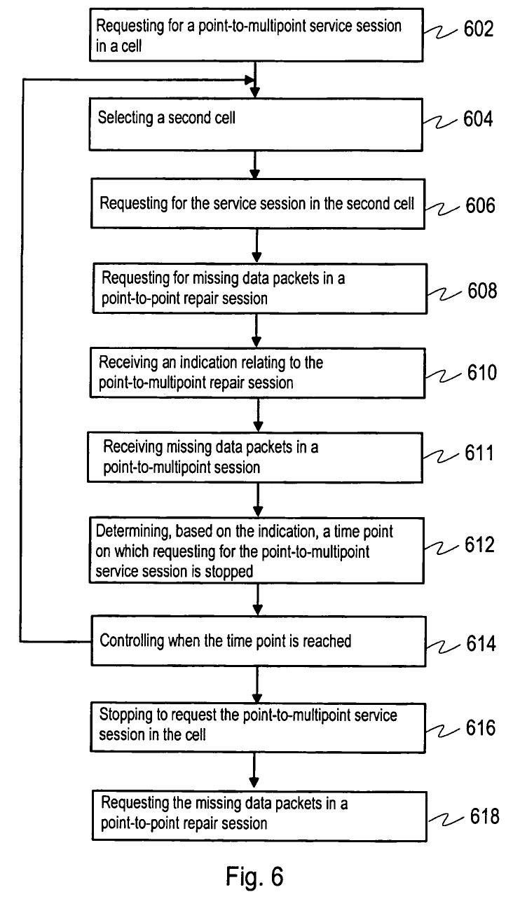

FIG. 6 shows a further embodiment of the invention. In step 602, a point-to-multipoint service session is requested for in a cell. In step 604, a second cell is selected. In step 606, the service session is requested for in the second cell. In step 608, missing data packets are requested for in a point-to-point repair session. In step 610, an indication relating to the point-to-multipoint repair session is received. In step 611, missing data packets are received in a point-to-multipoint repair session. In step 612, based on the indication, a time point is determined on which requesting for the point-to-multipoint service session is stopped. In step 614, reaching the time point is controlled. In step 616, when the time point is reached, requesting the point-to-multipoint service session in the cell is stopped. In an embodiment, steps 604, 606, 608, 610, 611, 612 and 614 may be repeated. If there are still data packets, which have not been received, the missing data packets are requested in a point-to-point repair session, step 618.

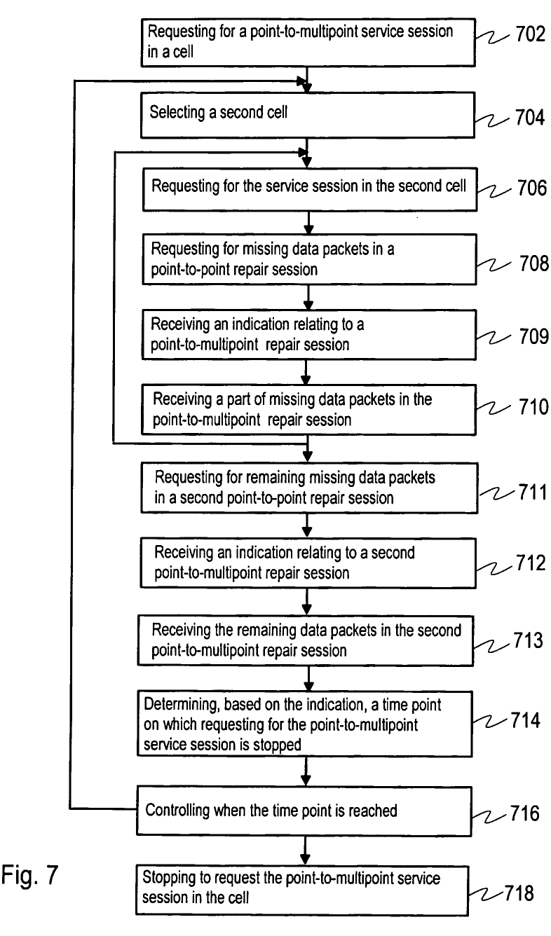

FIG. 7 shows a further embodiment of the invention. In step 702, a point-to-multipoint service session is requested for in a cell. In step 704, a second cell is selected. In step 706, the service session is requested for in the second cell. In step 708, missing data packets are requested for in a point-to-point repair session. In step 709, an indication relating to a point-to-multipoint repair session is received. In step 710, a part of missing data packets are received in the point-to-multipoint repair session. In step 711, remaining data packets are requested for in a second point-to-point repair session. In step 712, an indication relating to a second point-to-multipoint repair session is received. In step 713, the remaining data packets are received in the second point-to-multipoint repair session. In step 714, based on the indication, a time point is determined on which requesting for the point-to-multipoint service session is stopped. In step 716, reaching the time point is controlled. In step 718, when the time point is reached, requesting the point-to-multipoint service session in the cell is stopped. In an embodiment, steps from 704 to 716 may be repeated.

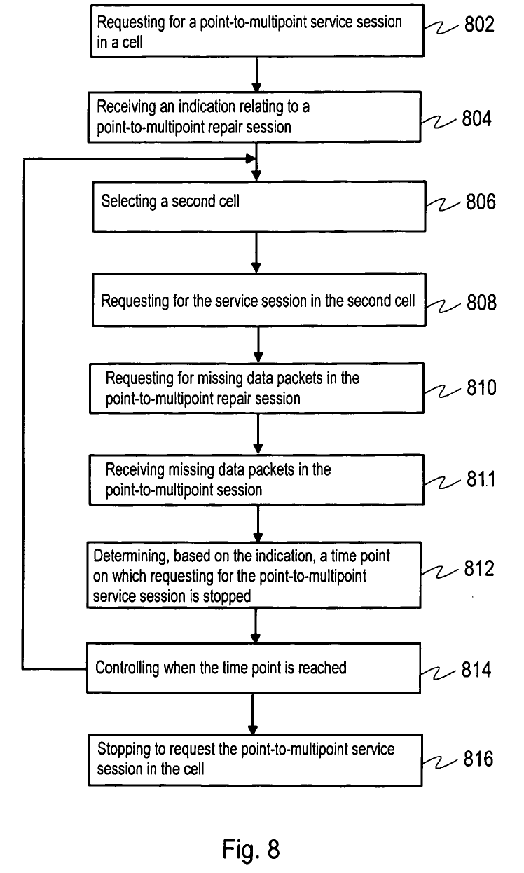

FIG. 8 shows a further embodiment of the invention. In step 802, a point-to-multipoint service session is requested for in a cell. In step 804, an indication relating to a point-to-multipoint repair session is received. In step 806, a second cell is selected. In step 808, the service session is requested for in the second cell. In step 810, missing data packets are requested for in the point-to-multipoint repair session. In step 811, missing data packets are received in the point-to-multipoint repair session. In step 812, based on the indication, a time point is determined on which requesting for the point-to-multipoint service session is stopped. In step 814, reaching the time point is controlled. In step 816, when the time point is reached, requesting the point-to-multipoint service session in the cell is stopped. In an embodiment, steps from 806 to 814 may be repeated.

An indication of a repair session may be received before requesting for a repair session. The embodiment of FIG. 8 may relate, for example, in a situation where the indication of a point-to-multipoint repair is received during a service announcement or in another stage before requesting for a repair. This order of steps may apply also in other embodiments. It shall thus appreciated that an indication of a lifetime of a session may be received before the session, for example in a service announcement, any time during the session, or after the session, for example when a repair is requested when the session is over.

Embodiments of the invention may provide a solution to avoid a loop effect in a cell reselection during an MBMS session. Embodiments may allow continuing with the MBMS reception even if the terminal was not able to receive the session continuously. For example, the terminal may have been, during the session, shortly outside the MBMS service area. Another example may comprise the serving MBMS cell being not able to provide p-t-m bearer for some other reason, such as congestion or not enough users for a p-t-m bearer.

As the MBMS cells in one MBMS service area may not be able to transmit the MBMS data synchronized, there can be a risk that a timer will expire shortly before or after the session is really stopped. However, this may be considered as a minor disadvantage compared to the loop effect possibility or to the possibility, that the terminal changes a cell outside the MBMS service area and the reception of the data is totally stopped. Using the safety period value, as explained above, may eliminate this risk. Other safety measures may also be used.

Although the invention has been described in the context of particular embodiments, various modifications are possible without departing from the scope and spirit of the invention as defined by the appended claims. In particular, even if a multimedia broadcast and multicast service is mainly used as an exemplifying service, embodiments of the invention may be implemented in another appropriate point-to-multipoint service. It shall also be appreciated that the order of method steps may vary in different implementations. As was explained, the indication relating to a lifetime of the session may be received before, during or after the session.

1. A method for providing information in a cellular communication network, the method comprising:
broadcasting a point-to-multipoint service in at least one cell; and
providing an indication for determining a time point on which requesting a point-to-multipoint service session of the point-to-multipoint service is to be stopped in the at least one cell.

2. The method according to claim 1, wherein the step of broadcasting comprises broadcasting at least one of a multimedia broadcast and multicast service.

3. The method according to claim 1, wherein the step of providing comprises providing an indication of a lifetime of the service session.

4. The method according to claim 3, wherein the step of providing comprises providing at least one of an indication of relative time duration of the service session, an absolute time indication of a stopping time of the service session, an amount of data to be transmitted during the service session, information of provision of a point-to-multipoint type of file repair and a safety period to be added in actual stopping time of the service session.

5. The method according to claim 1, further comprising broadcasting a point-to-multipoint repair session after the point-to-multipoint service session is stopped.

6. The method according to claim 1, wherein the step of providing comprises providing estimated session duration indicated as data amount to be transmitted and converting said information into time units, which tell a session duration time.

7. The method according to claim 1, wherein the step of providing comprises indicating in a service notification or in a service assignment message an expected duration time of a session.

8. A method for receiving information in a cellular communication network, the method comprising:
requesting for a point-to-multipoint service session broadcast in at least one cell;
receiving an indication; and
determining, based on the indication, a time point on which requesting the point-to-multipoint service session is stopped in the at least one cell.

9. The method according to claim 8, wherein the step of requesting comprises requesting at least one of a multimedia broadcast and multicast service session.

10. The method according to claim 8, wherein the step of receiving comprises receiving an indication of a lifetime of the service session.

11. The method according to claim 10, wherein the step of receiving comprises receiving at least one of an indication of relative time duration of the service session, an absolute time indication of a stopping time of the service session, an amount of data to be transmitted during the service session, information of provision of a point-to-multipoint type of file repair and a safety period to be added in actual stopping time of the service session.

12. The method according to claim 8, wherein the step of requesting comprises:
requesting for the service session in a first cell;
reselecting a second cell; and
requesting for the service session once after the step of reselecting.

13. The method according to claim 8, wherein the step of requesting comprises:
requesting for the service session in a first cell;
reselecting a second cell; and
requesting for the service session after the step of reselecting until the time point is reached.

14. The method according to claim 13, further comprising requesting for missing data packets in a point-to-multipoint repair session.

15. The method according to claim 14, wherein the step of requesting for the service session after the step of reselecting comprises requesting for the service session after the step of reselecting until all data packets requested in the point-to-multipoint repair session have been transmitted.

16. The method according to claim 15, further comprising, if not all the requested packets are received after the repair session, issuing a second repair request for residual missing packets.

17. The method according to claim 16, further comprising waiting for a further retransmission.

18. The method according to claim 15, further comprising, if not all the requested packets are received after the repair session, requesting for residual missing packets via a point-to-point connection.

19. The method according to claim 8, wherein the step of determining comprises determining the time point based on a session stop message or an indication via a serving cell.

20. The method according to claim 8, wherein the step of determining comprises determining the time point based on any pre-information or time indication indicating, that the session has stopped.

21. The method according to claim 19, wherein step of determining comprises determining the time point based on a session stop time defined in a service announcement.

22. The method according to claim 19, wherein step of determining comprises determining the time point based on a time indication given in a service joining phase or during a service session start or anytime before the session is stopped.

23. The method according to claim 19, wherein step of determining comprises determining the time point based on a time point obtained by summing an actual stop time and a safety period.

24. The method according to claim 19, wherein step of determining comprises determining the time point based on a service notification or a service assignment message.

25. The method according to claim 19, wherein step of determining comprises estimating session duration time by an indicated total data amount and a data rate used for transmission.

26. A method for controlling request for a point-to-multipoint service session broadcast in at least one cell, the method comprising:
requesting the point-to-multipoint service session in a cell;
receiving an indication;
determining, based on the indication, a time point on which requesting the point-to-multipoint service session is to be stopped in the cell;
reselecting a second cell;
repeating the steps of requesting and reselecting;
controlling when the time point is reached; and
stopping the step of requesting the point-to-multipoint service session in the cell when the time point is reached.

27. A computer program embodied on a computer readable medium, the computer program comprising means for performing the steps of:
broadcasting a point-to-multipoint service in at least one cell; and
providing an indication for determining a time point on which requesting a point-to-multipoint service session of the point-to-multipoint service is to be stopped in the at least one cell.

28. A computer program embodied on a computer readable medium, the computer program comprising means for performing the steps of:
requesting for a point-to-multipoint service session broadcast in at least one cell;
receiving an indication; and
determining, based on the indication, a time point on which requesting the point-to-multipoint service session is stopped in the at least one cell.

29. An entity in a cellular communication network for providing an indication for a point-to-multipoint service broadcast in at least one cell in the cellular communication network, the indication configured to allow determination of a time point on which requesting a point-to-multipoint service session of the point-to-multipoint service is to be stopped in the at least one cell.

30. The entity according to claim 29, wherein the point-to-multipoint service comprises at least one of a multimedia broadcast and multicast service.

31. The entity according to claim 29, wherein the indication comprises an indication of a lifetime of the service session.

32. The entity according to claim 31, wherein the indication comprises at least one of an indication of relative time duration of the service session, an absolute time indication of a stopping time of the service session, an amount of data to be transmitted during the service session, information of provision of a point-to-multipoint type of file repair and a safety period to be added in actual stopping time of the service session.

33. A broadcasting entity in a cellular communication network, configured to:
broadcast a point-to-multipoint service in at least one cell; and
provide an indication for determining a time point on which requesting a point-to-multipoint service session is to be stopped in the at least one cell.

34. A broadcasting entity in a cellular communication network, comprising:
a broadcaster for broadcasting a point-to-multipoint service in at least one cell; and
an indication provider for providing an indication for determining a time point on which requesting a point-to-multipoint service session of the point-to-multipoint service is to be stopped in the at least one cell.

35. A communication network, configured to:
broadcast a point-to-multipoint service in at least one cell; and
provide an indication for determining a time point on which requesting a point-to-multipoint service session of the point-to-multipoint service is to be stopped in the at least one cell.

36. A communication device, configured to:
request for a point-to-multipoint service session broadcast in at least one cell;
receive an indication; and
determine, based on the indication, a time point on which requesting the point-to-multipoint service session is stopped in the at least one cell.

37. The communication device according to claim 36, further configured to stop requesting the point-to-multipoint service session at the time point.

38. A communication device, configured to:
request for a point-to-multipoint service session in a cell;
receive an indication;
determine, based on the indication, a time point on which requesting the point-to-multipoint service session is to be stopped in the at least one cell;
reselect a second cell;
repeat the steps of requesting and reselecting;
control when the time point is reached; and
stop to request the point-to-multipoint service session in the at least one cell when the time point is reached.

39. A method for providing information in a cellular communication network, the method comprising:
broadcasting a point-to-multipoint service in one or more cells to one or more mobile stations;
providing an indication to said one or more mobile stations;
determining, based on the indication, in any of said one or more mobile stations a time point on which to stop requesting in any of said one or more cells a point-to-multipoint service session of the said point-to-multipoint service if said any mobile station has already attempted acquiring data for this said session.
